(19) United States
(12) Patent Application Publication
(10) Pub. No.: US 2025/0233782 A1
(43) Pub. Date: Jul. 17, 2025

(54) METHOD OF CORRECTING ERRORS IN AN IQ SIGNAL GENERATOR SYSTEM

(71) Applicant: Rohde & Schwarz GmbH & Co. KG, Muenchen (DE)

(72) Inventor: Joerg NAGEL, Muenchen (DE)

(21) Appl. No.: 18/960,509

(22) Filed: Nov. 26, 2024

(30) Foreign Application Priority Data
Jan. 16, 2024 (EP) 24 152 222.6

(51) Int. Cl. H04L 25/49; H04L 1/24

(52) U.S. Cl. CPC H04L 25/4921; H04L 1/245

(57) ABSTRACT

A method of correcting an error in an IQ signal generator system includes: generating, by a baseband circuit, a baseband IQ signal having a baseband I signal part and a baseband Q signal part; modulating, by an IQ modulator circuit, the baseband IQ signal, thereby obtaining a modulated IQ signal; determining, by an analysis circuit, a level curve of the modulated IQ signal, wherein the level curve is associated with a signal level of the modulated IQ signal over time; determining, by the analysis circuit, at least one error quantity based on the level curve, wherein the level curve multiplied with a spectral factor is integrated in order to determine the at least one error quantity; and controlling, by a control circuit, the baseband circuit or the IQ modulator circuit based on the at least one error quantity determined, thereby correcting an error in the IQ signal generator system.

### FIELD OF THE DISCLOSURE

Embodiments of the present disclosure generally relate to a method of correcting errors in an IQ signal generator system. Embodiments of the present disclosure further relate to an IQ signal generator system.

### BACKGROUND

IQ signal generator systems usually comprise a baseband circuit generating an in-phase (I) signal part and a quadrature (Q) signal part, and a modulation module that generates a modulated IQ signal based on the I signal part and the Q signal part.

In such IQ signal generator systems, different types of errors can occur that impair the signal quality of the modulated IQ signal. Conventional error suppression techniques rely on measurements that are performed by external measurement devices such as a spectrum analyzer. Based on the measurements, correction quantities are determined and the operational parameters of the IQ signal generator system are adapted accordingly.

Accordingly, the known error suppression techniques require additional measurement hardware, thereby increasing the effort and costs for correcting the errors.

Thus, there is a need for a method of correcting errors in an IQ signal generator system that is easier and more cost-efficient to perform.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of correcting errors in an IQ signal generator system. The IQ signal generator system comprises, for example, a baseband circuit, an IQ modulator circuit, an analysis circuit, and a control circuit. In an embodiment, the method comprises:
generating, by the baseband circuit, a baseband IQ signal having a baseband I signal part and a baseband Q signal part;
modulating, by the IQ modulator circuit, the baseband IQ signal, thereby obtaining a modulated IQ signal;
determining, by the analysis circuit, a level curve of the modulated IQ signal, wherein the level curve is associated with a signal level of the modulated IQ signal over time;
determining, by the analysis circuit, at least one error quantity based on the level curve, wherein the at least one error quantity is indicative of at least one error in the IQ signal generator system, wherein the level curve multiplied with a spectral factor is integrated in order to determine the at least one error quantity; and
controlling, by the control circuit, the baseband circuit and/or the IQ modulator circuit in dependence of the at least one error quantity determined, thereby correcting the at least one error in the IQ signal generator system.

The term “level function” is understood to denote a discrete function or a continuous function that describes a quantity associated with the signal level of the modulated IQ signal, for example over time or phase. For example, the level function may describe an amplitude of the modulated IQ signal or a power of the modulated IQ signal.

Examples of the method according to one or more aspects of the present disclosure are based on the finding that the level function described above comprises information on errors occurring in the IQ signal generator system. In particular, as will be described in more detail below, the level function comprises information on I-offsets, Q-offsets, IQ gain imbalances, and IQ quadrature errors.

Accordingly, the at least one error quantity describing the at least one error can be determined based on the determined level function, and the at least one error can be corrected by the control circuit. In particular, the at least one error quantity can be determined by integrating the level function multiplied with the spectral factor over time or phase. It is noted that integrating over time and integrating over phase are equivalent options.

Examples of the method according to one or more aspects of the present disclosure do not need external measurement devices in order to be performed. In an embodiment, the analysis circuit and the control circuit may be integrated into the same electronic device comprising the IQ signal generator system. Thus, the effort and costs for correcting the errors described above are reduced.

The various methods may be performed partially or completely by software of the electronic device comprising the IQ signal generator system. Accordingly, examples of the method may be a computer-implemented method.

According to an aspect of the present disclosure, the at least one error quantity, for example, is indicative of an I-offset, a Q-offset, an IQ gain imbalance, and/or an IQ quadrature error. Thus, the I-offset, the Q-offset, the IQ gain imbalance, and/or the IQ quadrature error may be corrected automatically by the control circuit based on the at least one error quantity determined.

Therein and in the following, the term “I-offset” is understood to denote the effect of a constant offset of the baseband I signal part onto the modulated IQ signal and/or cross-talk effects between a local oscillator signal applied to the I signal part and the modulated IQ signal due to imperfections in the IQ modulator circuit.

Likewise, the term “Q-offset” is understood to denote the effect of a constant offset of the baseband Q signal part onto the modulated IQ signal and/or cross-talk effects between a local oscillator signal applied to the Q signal part and the modulated IQ signal due to imperfections in the IQ modulator circuit.

The term “IQ gain imbalance” is understood to denote a gain imbalance between a signal path processing the baseband I signal part and a signal path processing the baseband Q signal part. These signal paths may each comprise amplifiers, attenuators, filters, etc., which may influence the gain applied to the baseband I signal part and the baseband Q signal part.

The term “IQ quadrature error” is understood to denote a deviation from orthogonality of an I signal portion and a Q signal portion in the modulated IQ signal. For example, this may occur if the local oscillator signal used for modulation is applied to the baseband I signal part and the baseband Q signal part with a phase difference being different from 90°, i.e. with a phase difference that is not exactly 90°.

In an embodiment, the level curve is an envelope of the modulated IQ signal. In the context of the present disclosure, the term “envelope” is understood to denote a function, for example a smooth function, outlining the signal level of the modulated IQ signal. In an embodiment, the envelope of the modulated IQ signal may be equal to the instantaneous amplitude of the modulated IQ signal.

In an embodiment, the analysis circuit may comprise an envelope detector, wherein the level curve is determined by the envelope detector. Such envelope detectors usually are provided in IQ signal generator systems anyway. Thus, no further hardware or other measurement equipment is necessary for determining the level function, thereby reducing the effort and costs for suppressing the unwanted signal portions.

Another aspect of the present disclosure provides, for example, that the baseband IQ signal is a single-tone signal. Thus, the method according to the present disclosure can be performed with a particularly simple test signal, namely the baseband IQ signal being a single-tone signal.

In an embodiment, the baseband circuit may be established as or comprise a single sideband generator. Accordingly, the modulated IQ signal may be a single sideband signal.

In another embodiment, the spectral factor depends on a frequency of the baseband IQ signal. In an embodiment, the spectral factor may be sin [symbol] [symbol] (n·π·F·t) [symbol] or cos [symbol] [symbol] (n·π·F·t) [symbol] , wherein n is an integer, F is the absolute value of the frequency of the baseband IQ signal, and t is time. In an embodiment, n may be equal to 2 or 4.

According to another aspect of the present disclosure, the level curve multiplied with the spectral factor, for example, is integrated over one period of the baseband IQ signal or over a multiple of the period of the baseband IQ signal, for example wherein the spectral factor is integrated over an integer multiple of the period of the baseband IQ signal. The period of the baseband signal is the inverse of the frequency of the baseband IQ signal. While integrating over one period of the baseband IQ signal is enough in order to determine the at least one error quantity, uncorrelated distortions in the level function can be suppressed by integrating over a multiple of the period, for example over an integer multiple of the period.

In an embodiment, a frequency of the baseband IQ signal may be smaller than a bandwidth of the analysis circuit, for example smaller than half the bandwidth of the analysis circuit. Therein, the term “bandwidth of the analysis circuit” refers to the bandwidth processable by a component of the analysis circuit that determines the level function. Thus, it is ensured that the level function can be determined accurately.

For example, the analysis circuit may comprise an envelope detector that is configured to determine the level function. In this case, the frequency of the baseband IQ signal may be smaller than the bandwidth of the envelope detector, for example smaller than half the bandwidth of the envelope detector.

In an embodiment, an offset is added to the baseband I signal part and/or to the baseband Q signal part in order to correct the at least one error. By adding the offset to the baseband I signal part, an I-offset can be corrected. Likewise, by adding the offset to the baseband Q signal part, a Q-offset can be corrected.

In an embodiment, a gain applied to the baseband I signal part and/or a gain applied to the baseband Q signal part are/is adjusted in order to correct the at least one error. This way, an IQ gain imbalance between the baseband I signal part and the baseband Q signal part can be corrected.

A further aspect of the present disclosure provides, for example, that an adapted baseband I signal part is determined, wherein the adapted baseband I signal part is a linear combination of the baseband I signal part and the baseband Q signal part. Alternatively or additionally, an adapted baseband Q signal part is determined, wherein the adapted baseband Q signal part is a linear combination of the baseband I signal part and the baseband Q signal part. This way, an IQ quadrature error can be corrected. In other words, the IQ quadrature error is corrected by a predistortion of the baseband I signal part and/or of the baseband Q signal part.

In an embodiment, the baseband circuit may comprise a suitable filter that is configured to determine the adapted baseband I signal part and/or the adapted Q signal part.

In another embodiment, a phase difference between a local oscillator signal being applied to the I signal part and the local oscillator signal being applied to the Q signal part is adapted in order to correct the at least one error. For example, the phase of the local oscillator signal applied to the baseband I signal part and/or to the baseband Q signal part may be adapted such that the phase difference is exactly 90°. This way, an IQ quadrature error can be corrected.

According to another aspect of the present disclosure, the control circuit, for example, automatically adapts operational parameters of the IQ signal generator system in order to correct the at least one error. Accordingly, the at least one error may be corrected fully automatically, i.e. without intervention of an operator.

In an embodiment, the control circuit may automatically adapt operational parameters of the baseband circuit and/or of the IQ modulation circuit in order to correct the at least one error.

Another aspect of the present disclosure provides, for example, that a user input is received, and wherein the control circuit adapts operational parameters of the IQ signal generator system based on the received user input. Accordingly, the at least one error may be corrected based on the user input provided by an operator.

For example, the control circuit may determine adapted operational parameters that are suitable for correcting the at least one error, and the adapted operational parameters may be displayed on a display. The operator may confirm the adapted operational parameters or may further adjust the adapted operational parameters by the user input.

Embodiments of the present disclosure further provide an IQ signal generator system. In an embodiment, the IQ signal generator system comprises a baseband circuit, an IQ modulator circuit, an analysis circuit, and a control circuit. The IQ signal generator system is configured to perform the method described above.

In an embodiment, the IQ signal generator system is configured to perform the method according to any one of the variants described above.

Regarding the advantages and further properties of the IQ signal generator system, reference is made to the explanations given above with respect to the method, which also hold for the IQ signal generator system and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an electronic device with an IQ signal generator system according to an embodiment of the present disclosure;

FIG. 2 shows an example of a flow chart of a method of correcting errors in an IQ signal generator system according to an embodiment of the present disclosure;

FIG. 3 shows plots of a modulated IQ signal without errors in the IQ signal generator system; and

FIG. 4 shows plots of a modulated IQ signal with errors being present in the IQ signal generator system.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

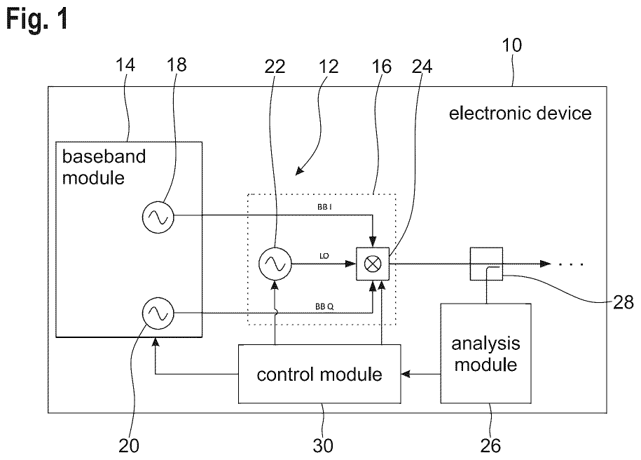

FIG. 1 schematically shows an example embodiment of an electronic device 10 comprising an IQ signal generator system 12. For example, the electronic device 10 may be a signal generator being configured to generate a test signal for testing a device under test. As another example, the electronic device 10 may be a test and/or measurement instrument for testing mobile network devices, broadcasting devices, RF transmitters, RF receivers, or other wireless communication devices. As a further example, the electronic device 10 may be an RF transmitter, a wireless communication device, for example a WLAN device, a TV transmitter, etc. However, it is to be understood that the electronic device 10 may be any other type of device with built-in IQ signal generator.

In an embodiment, the IQ signal generator system 12 comprises a baseband circuit 14 and an IQ modulator circuit 16. In general, the baseband circuit 14 is configured to generate a baseband IQ signal having a baseband I signal part (“BB I” in FIG. 1) and a baseband Q signal part (“BB Q” in FIG. 1).

In an embodiment, the baseband circuit 14 comprises a first signal generator unit 18, and a second signal generator unit 20. The first signal generator unit 18 is configured to generate the baseband I signal part, while the second signal generator unit 20 is configured to generate the baseband Q signal part.

In an embodiment, the baseband circuit 14 or the signal generator units 18, 20 may establish a single sideband generator. In an embodiment, the baseband I signal part and the baseband Q signal part may have the same frequency F, such that baseband IQ signal is a single-tone signal.

In the example embodiment of FIG. 1, the IQ modulator circuit 16 comprises a local oscillator 22 that is configured to generate a local oscillator (LO) signal having a certain frequency and phase, wherein the frequency and phase of the LO signal may be tunable. In an embodiment, the IQ modulator circuit 16 further comprises a mixer circuit 24 that is configured to receive the baseband I signal part, the baseband Q signal part, and the LO signal, and to generate a modulated IQ signal based on the LO signal and the baseband signal parts.

In an embodiment, the baseband circuit 14 and the IQ modulator circuit 16 may be configured such that a travel time of the baseband I signal part to the mixer circuit 24 is equal to a travel time of the baseband Q signal part to the mixer circuit 24.

The modulated IQ signal may be provided, for example, to further components of the electronic device 10, as is indicated by the dots in FIG. 1. For example, the further components may comprise an RF frontend that is configured to up-convert the modulated IQ signal to an RF signal.

In an embodiment, the electronic device 10 further comprises an analysis circuit 26 that is provided downstream of the IQ modulator circuit 16. In the example embodiment shown in FIG. 1, the analysis circuit 26 is connected to the mixer circuit 24 by a directional coupler 28, such that the modulated IQ signal is forwarded to the analysis circuit 26 via the directional coupler 28. However, it is to be understood that the analysis circuit 26 may be connected to the mixer circuit 24 by any other suitable type of connection.

In the example embodiment of FIG. 1, the electronic device 10 further comprises a control circuit 30 that is connected to the analysis circuit 26 downstream of the analysis circuit 26. The control circuit 30, for example, is further connected to the baseband circuit 14, the local oscillator 22, and/or to the mixer circuit 24. In an embodiment, the control circuit 30 may be synchronized with the baseband circuit 14 and/or with the IQ modulator circuit 16, for example with the local oscillator 22.

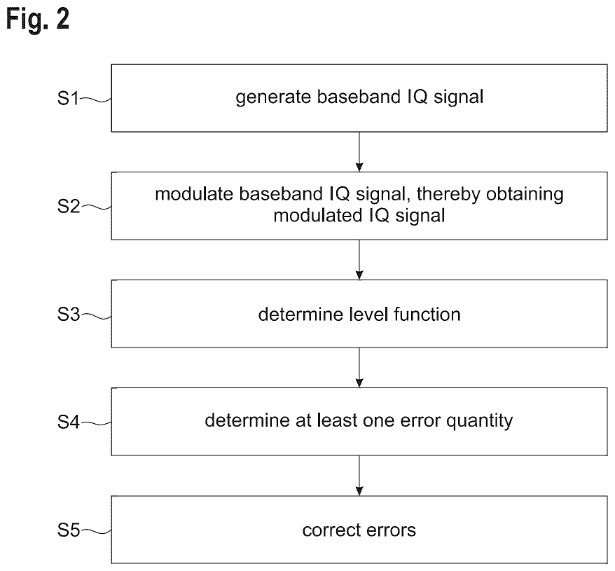

The electronic device 10 or the IQ signal generator system 12 is configured to perform a method of correcting errors in the IQ signal generator system 12, an example of which is described hereinafter with reference to FIG. 2.

At the beginning of the method, the baseband IQ signal described above is generated by the baseband circuit 14 (step S1). Without restriction of generality, the case of the baseband IQ signal being a single-tone signal is described hereinafter.

Accordingly, the baseband IQ signal is periodic with a period T=1/F. Therein, the frequency F of the baseband IQ signal may be chosen such that the frequency F is smaller than a predetermined threshold.

For example, the analysis circuit 26 may comprise an envelope detector having a certain bandwidth. In this case, the predetermined threshold may be equal to the bandwidth of the envelope detector or equal to half the bandwidth of the envelope detector.

The baseband IQ signal is modulated by the IQ modulator circuit 16, thereby obtaining the modulated IQ signal (step S2). The modulated IQ signal may be a single sideband signal. The modulated IQ signal is forwarded to the analysis circuit 26, for example via the directional coupler 28.

A level function describing a signal level of the modulated IQ signal over time is determined by the analysis circuit 26 (step S3). In general, the level function may be a discrete function or a continuous function describing the signal level, for example the amplitude and/or the power of the modulated IQ signal over time.

In an embodiment, the level function may be an envelope of the amplitude or power of the modulated IQ signal plotted against time. In an embodiment, the analysis circuit 26 may comprise an envelope detector that is configured to determine the envelope of the modulated IQ signal.

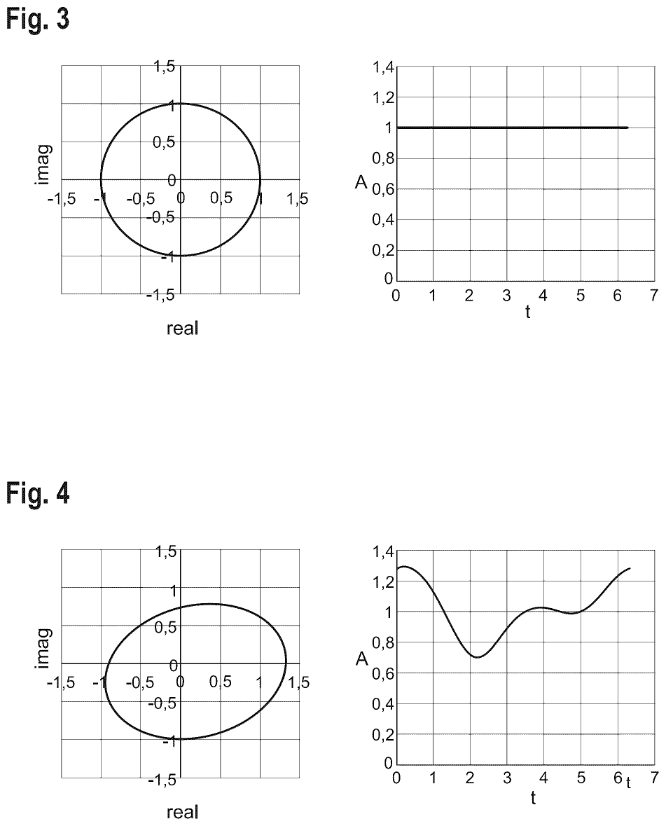

At least one error quantity is determined based on the determined level function, wherein the at least one error quantity is indicative of at least one error in the IQ signal generator system 12 (step S4). As is illustrated in FIGS. 3 and 4, the type and severity of the at least one error can be determined based on the determined level function.

The left diagram in FIG. 3 shows a constellation diagram of the level function corresponding to the modulated IQ signal for the case of no error being present in the IQ signal generator system 12. As can be seen, the constellation diagram is substantially circular if no error is present.

The right diagram in FIG. 3 shows the determined level function plotted against time. As can be seen, the determined level function is constant if no errors are present.

FIG. 4 shows the constellation diagram as well as the level function for the case of an error being present. Due to the error(s), the constellation diagram deviates from the circular form and is deformed elliptically. This deformation may be caused by an IQ gain imbalance and/or by an IQ quadrature error.

Moreover, a center of the constellation diagram of the level function is shifted away from the origin, i.e. from (I,Q)=(0,0). This shift may be caused by an I-offset and/or by a Q-offset. Further, the determined level function is not constant but varies over time.

In a linear approximation, the I-offset, the Q-offset, the IQ gain imbalance and the IQ quadrature error are described by or proportional to the error quantities E_{IQ,I}, E_{IQ,Q}, E_{IQ,g} and E_{IQ,quad}, respectively, which are given by

$${E}_{IQ , I} = {\int }_{0}^{n \cdot T} A ( t ) cos ( 2 π \cdot F \cdot t ) dt ,$$

$${E}_{IQ , Q} = {\int }_{0}^{n \cdot T} A ( t ) sin ( 2 π \cdot F \cdot t ) dt ,$$

$${E}_{IQ , g} = {\int }_{0}^{n \cdot T} A ( t ) cos ( 4 π \cdot F \cdot t ) dt ,$$

$${E}_{IQ , quad} = {\int }_{0}^{n \cdot T} A ( t ) sin ( 4 π \cdot F \cdot t ) dt .$$

Therein, n is a number equal to or greater than 1, A(t) is the determined level function, and T=1/F is the period of the modulated IQ signal. In an embodiment, n is an integer equal to or greater than 1.

It is noted that these error quantities can be interpreted to be the real and imaginary parts of coefficients of a Fourier series of the level function A(t), which is periodic with period T.

The at least one determined error quantity or the determined error quantities is/are forwarded to the control circuit 30.

The baseband circuit 14 and/or the IQ modulator circuit 16 are controlled by the control circuit 30 in dependence of the at least one error quantity determined, such that the at least one error corresponding to the at least one error quantity is corrected (step S5).

For example, if the at least one error comprises an IQ gain imbalance, a gain applied to the baseband I signal part and/or a gain applied to the baseband Q signal part may be adjusted in order to correct at least one error.

For example, at least one attenuator, at least one amplifier, and/or at least one filter comprised in the baseband circuit 14 and/or in the IQ modulator circuit 16 may be controlled to adjust the gain applied to the baseband I signal part and/or to the baseband Q signal part.

As another example, if the at least one error comprises an IQ quadrature error, the baseband I signal part and/or the baseband Q signal part may be adapted by an appropriate filter, for example by a filter of the baseband circuit 14.

In an embodiment, the filter may determine an adapted baseband I signal part I′, which corresponds to a linear combination of the baseband I signal part and the baseband Q signal part, i.e. I′=a₁I+b₁Q. Further, the filter may determine an adapted baseband Q signal part Q′, which corresponds to a linear combination of the baseband I signal part and the baseband Q signal part, i.e. Q′=a₂I+b₂Q. Therein, the filter coefficients aᵢ, bᵢ are determined such that the IQ quadrature error is compensated.

Alternatively or additionally, the phases of the LO signal applied to the baseband I signal part and/or to the baseband Q signal part by the mixer circuit 24 may be adapted such that the phase difference is exactly 90°.

If the at least one error comprises an I-offset and/or a Q-offset, a constant offset may be added to the baseband I-signal and/or to the baseband Q-signal in order to account for the respective offset.

Summarizing, operational parameters of the signal generator system 12, for example of the baseband circuit 14 and/or of the IQ modulator circuit 16, are adapted by the control circuit 30 in order to correct the at least one error. The operational parameters may be adapted fully automatic, i.e. without further input of an operator being required.

However, it is also conceivable that the control circuit 30 may adapt the operational parameters based on user input. For example, an operator may confirm adapted operational parameters suggested by the control circuit 30 or may further adjust the adapted operational parameters suggested by the control circuit 30 by the user input.

In an embodiment, the correction described above may be performed iteratively, such that the (absolute) value of the at least one error quantity decreases with each iteration. Alternatively, a single correction step may be applied.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the electronic device 10 referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of correcting errors in an IQ signal generator system, the IQ signal generator system comprising a baseband circuit, an IQ modulator circuit, an analysis circuit, and a control circuit, wherein the method comprises:
generating, by the baseband circuit, a baseband IQ signal having a baseband I signal part and a baseband Q signal part;
modulating, by the IQ modulator circuit, the baseband IQ signal, thereby obtaining a modulated IQ signal;
determining, by the analysis circuit, a level curve of the modulated IQ signal, wherein the level curve is associated with a signal level of the modulated IQ signal over time;
determining, by the analysis circuit, at least one error quantity based on the level curve, wherein the at least one error quantity is indicative of at least one error in the IQ signal generator system, wherein the level curve multiplied with a spectral factor is integrated in order to determine the at least one error quantity; and
controlling, by the control circuit, the baseband circuit and/or the IQ modulator circuit in dependence of the at least one error quantity determined, thereby correcting the at least one error in the IQ signal generator system.

2. The method of claim 1, wherein the at least one error quantity is indicative of an I-offset, a Q-offset, an IQ gain imbalance, and/or an IQ quadrature error.

3. The method of claim 1, wherein the level curve is an envelope of the modulated IQ signal.

4. The method according to claim 3, wherein the analysis circuit comprises an envelope detector, and wherein the level curve is determined by the envelope detector.

5. The method according to claim 1, wherein the baseband IQ signal is a single-tone signal.

6. The method according to claim 1, wherein the spectral factor depends on a frequency of the baseband IQ signal.

7. The method according to claim 1, wherein the level curve multiplied with the spectral factor is integrated over one period of the baseband IQ signal or over a multiple of the period of the baseband IQ signal.

8. The method of claim 7, wherein the spectral factor is integrated over an integer multiple of the period of the baseband IQ signal.

9. The method according to claim 1, wherein a frequency of the baseband IQ signal is smaller than a bandwidth of the analysis circuit.

10. The method of claim 9, wherein the frequency of the baseband IQ signal is smaller than half the bandwidth of the analysis circuit.

11. The method according to claim 1, wherein an offset is added to the baseband I signal part and/or to the baseband Q signal part in order to correct the at least one error.

12. The method according to claim 1, wherein a gain applied to the baseband I signal part and/or a gain applied to the baseband Q signal part are/is adjusted in order to correct the at least one error.

13. The method according to claim 1, wherein an adapted baseband I signal part is determined, wherein the adapted baseband I signal part is a linear combination of the baseband I signal part and the baseband Q signal part.

14. The method of claim 1, wherein an adapted baseband Q signal part is determined, wherein the adapted baseband Q signal part is a linear combination of the baseband I signal part and the baseband Q signal part.

15. The method according to claim 1, wherein a phase difference between a local oscillator signal being applied to the I signal part and the local oscillator signal being applied to the Q signal part is adapted in order to correct the at least one error.

16. The method according to claim 1, wherein the control circuit automatically adapts operational parameters of the IQ signal generator system in order to correct the at least one error.

17. The method according to claim 1, wherein a user input is received, and wherein the control circuit adapts operational parameters of the IQ signal generator system based on the received user input.

18. An IQ signal generator system, comprising: a baseband circuit, an IQ modulator circuit, an analysis circuit, and a control circuit, wherein the IQ signal generator system is configured to perform the method according to claim 1.

19. A non-transitory computer readable media having executable instructions embodied thereon that, when executed by processor circuitry, cause the processor circuitry to perform the method of claim 1.
